(19) United States
(12) Patent Application Publication
(10) Pub. No.: US 2009/0120055 A1
(43) Pub. Date: May 14, 2009

(54) METHOD AND APPARATUS FOR PROPELLING A VESSEL IN A ZERO GRAVITY ENVIRONMENT

(76) Inventor: Gregory J. Osborn, Monroe, MI (US)

Correspondence Address: WILLIAM D. HARE, 66 WITHERSPOON STREET, STE. 1, PMB 317, PRINCETON, NJ, 08542-9944, US

(21) Appl. No.: 12/247,211

(22) Filed: Oct. 7, 2008

Related U.S. Application Data
(60) Provisional application No. 60/978,182, filed on Oct. 8, 2007.

(51) Int. Cl. H05H 15/00

(52) U.S. Cl. 60/202

(57) ABSTRACT

The invention relates to a space vessel that includes the vessel, at least one propulsion unit mounted to the vessel, and a source of particles. The propulsion unit includes a hollow body having a first end and a second end. The first end includes a circuit and a speaker. The circuit includes an antenna and a diode and the speaker is configured to receive the signal from the circuit. The second end includes a flexible membrane. The invention also relates to the propulsion unit itself and methods of propelling space vessels using radio-frequency waves.

### CROSS REFERENCE TO RELATED APPLICATIONS

This application claims priority as a non-provisional application of U.S. provisional patent application No. 60/978,182, filed on Oct. 8, 2007, the contents of which are incorporated herein in their entirety by reference.

### TECHNICAL FIELD

The field of the invention generally relates to methods and apparatus for propelling and/or steering a vessel in a zero gravity environment using energy from RF waves.

### BACKGROUND

Space vessels are launched into space using immense quantities of fuel or propellant. These immense quantities of fuel are necessary to overcome the earth's gravity. There is a proportional relationship between the mass of the space vessel being launched and the quantity of fuel need to launch the vessel into space. Thus, any progress in reducing the weight of the space vessel or its contents will reduce the quantity of fuel needed.

Moreover, once in space, the vessel will need a source of fuel to propel the vessel in space, control the direction of the vessel and slow the vessel down as it approaches its destination. This fuel can be a significant amount of weight for the vessel depending upon the distance the vessel is traveling. The inventor has developed means and methods for propelling a vessel in space in a zero gravity environment that can reduce or eliminate the need to provide a source of fuel in space. By reducing or eliminating the need to provide fuel for travel in the zero gravity environment, the inventor is able to provide light space vessels and/or space vessel propulsion systems.

The prior art discloses various systems for space propulsion. For example, U.S. Pat. No. 4,838,021 to Beattie, titled “Electrostatic ion thruster with improved thrust modulation” discloses an ion propulsion system. The propulsion system includes an ionizing system for ionizing a gaseous propellant within a chamber to produce a plasma. The ionizing system includes a cathode to provide a source of electrons and anodes to accelerate the electrons to velocities sufficient to ionize the gaseous propellant. The propulsion system further includes an ion extraction system for expelling an ion beam from the plasma.

U.S. Pat. No. 6,145,298 to Burton, titled “Atmospheric fueled ion engine” discloses a propulsion system for low maintenance and long term durations at high altitudes. The propulsion system uses high altitude ambient gas as fuel and produces ozone as a by-product of the propulsion. The ion engine propulsion system ionizes a portion of an ambient atmospheric fuel to create a negative ionic plasma for bombarding and accelerating the remaining portion of the ambient atmospheric gas in a focused and directed path to an ion thruster anode. The ion engine creates a negative ionic plasma between a cathode ion thruster and a ring-shaped anode in a housing composed of an electrical insulative material in which the cathode ion thruster is charged to −18 to −110 kilovolts (kv) to utilize ambient atmospheric gas as the propellant.

U.S. Pat. No. 6,195,980 to Walther, titled “Electrostatic propulsion engine with neutralizing ion source,” discloses an electrostatic ion propulsion engine for satellites and spacecraft. The engine is equipped with an electron source for neutralizing the propellant gas ion beam or jet emitted by the engine. The electron source includes an anode housing, a hollow cathode tube with gas flowing there through, a cathode element at the outlet end of the cathode tube within the interior space of the anode housing, and a pin- or rod-shaped auxiliary electrode arranged along the lengthwise axis in the hollow cathode tube. An ignition pulse is applied to the auxiliary electrode relative to the cathode tube, which causes a pulse discharge in the cathode tube, and in turn ignites the gas discharge between the anode and the cathode which generates the electron current.

U.S. Pat. No. 6,293,090 to Olson, titled “More efficient RF plasma electric thruster,” discloses a radio frequency (RF) plasma thruster for use in electric propulsion for spacecraft. The thruster operates by heating plasma in a magnetic field, which then flows out along magnetic field lines, producing axial thrust. The electric thruster utilizes a lower hybrid wave for heating of the electrons, rather than electron cyclotron resonance (ECR) heating. The lower hybrid wave is used because it creates high-density plasmas and the antennas used to couple RF energy to the plasma are described as being relatively simple to construct. This allows much better efficiency because no hot electron population is created to siphon off much of the RF power applied to the plasma.

U.S. Pat. No. 6,357,700 to Provitola, titled “Electrically powered spacecraft/airship,” discloses a spacecraft/airship that uses buoyancy and thrusters to ascend into space with lifting gas as propellant or fuel for thrusters. The thrusters may be conventional thrusters or electric turbojets or ion thrusters. The airship aspect has gas retaining structures that can regulate the density of the gasses within. The spacecraft aspect provides for mounting thrusters, control, power, services, and interior space for missions of the spacecraft/airship. The reference also discloses using microwave antennae for receiving beamed microwave energy with the gas retaining structures in order to supply the spacecraft/airship and its electrically powered thrusters with electric power.

U.S. Pat. No. 6,565,044 to Johnson, titled “Combination solar sail and electrodynamic tether propulsion system,” discloses a propulsion system for a spacecraft. The propulsion system includes a solar sail system and an electrodynamic tether system. The solar sail system is used to generate propulsion to propel the spacecraft through space using solar photons and the electrodynamic tether system is used to generate propulsion to steer the spacecraft into orbit and to perform orbital maneuvers around a planet using the planet's magnetic field. The electrodynamic tether system can also be used to generate power for the spacecraft using the planet's magnetic field. The electrodynamic tether systems measure the strength and direction of a planet's magnetic field and adjust the current flowing through the electrodynamic tethers to generate propulsion and power for a spacecraft.

U.S. Pat. No. 6,723,912 to Mizuno, titled “Space photovoltaic power generation system,” discloses a power generation satellite that has a photoelectric conversion unit for converting sunlight into electric energy, a transmission frequency conversion unit for performing frequency conversion of the electric energy to a microwave, a microwave control unit for controlling the amplitude, the phase, or the amplitude and the phase of the microwave, and a transmitting antenna for radiating the microwave. A plurality of the power generation satellites are placed in space to form a power generation satellite group and an array antenna having the transmitting antennas of the power generation satellites in the power generation satellite group as element antennas is formed. The space photovoltaic generation system thereby converts sunlight into electric energy in space and the electric power is transmitted by microwave, etc., to a power base where it is converted into electric energy.

US Patent Publication No. 20020047622 to Cardwell, titled “Started Circuit for an Ion Engine,” is directed to a starter circuit for a plasma of an ion engine for a spacecraft. The spacecraft has a thruster housing that houses an ion thruster. The spacecraft further includes solar panels as a source of electrical power. The spacecraft is powered by xenon ions which are generated in an ion thruster and includes a xenon feed subsystem supplying xenon to the thruster. A digital interface and control unit (DCIU) is also coupled to the thruster housing.

### SUMMARY

In one general aspect, a space vessel includes at least one propulsion unit mounted to the vessel, and a source of particles. The propulsion unit includes a hollow body having a first end and a second end. The first end includes a circuit and a speaker. The circuit includes an antenna and a diode and the speaker is configured to receive the signal from the circuit. The second end includes a flexible membrane.

Embodiments of the space vessel may include one or more of the following features. For example, the space vessel may further include an ion collector that is configured to provide the particles. The ion collector may be configured to provide the particles onto the flexible membrane. The flexible membrane may be a Mylar® or an aluminum sheet.

The ion collector may include a packing ring mounted to the hollow body and comprising a first material, a collar adjacent to the packing ring and comprising a second material, and a fiber mesh within the sheet, the fiber mesh comprising the first material and the second material and being in continuity with the first material of the packing ring and the second material of the collar. The first material and the second material may be made of materials having a difference on the triboelectric scale whereby a movement of the collar against the packing ring causes the creation of a charge resulting from the different in the triboelectric values.

The circuit may further include a circuit element to tune the frequency of the circuit. The frequency of the circuit may be the resonant frequency of the flexible membrane mounted to the hollow body.

The space vessel may further include multiple propulsion units mounted to the space vessel. The propulsion units may provide one or more of forward thrust, reverse thrust, and direction control. The propulsion units may be controlled from a remote location.

The antenna may be configured to receive radio-frequency waves. The diode may be a GE diode.

In another general aspect there is provided a component for a propulsion unit for a space vessel. The component includes a hollow body having a first end and a second end. The first end may include a circuit and a speaker and the circuit may include an antenna configured to receive radio-frequency waves and a diode configured to convert the radio-frequency waves into a signal in the circuit. The speaker is configured to receive the signal from the circuit and oscillate such that the speaker emits a sound. The second end includes a flexible membrane configured to flex as a result of the sound emitted by the speaker.

Embodiments of the component for a propulsion unit may include one or more of the following features or those described above. For example, the component for a propulsion unit may further comprise a source for ions and charged particles. The source for ions and charged particles may be an ion collector. The ion collector and component may be mounted to a space vessel. The diode may be a GE diode.

In another general aspect there is provided a method for propelling a space vessel. The method includes receiving radio-frequency waves at an antenna to create a signal in a circuit, modifying the signal in the circuit with a GE diode to create a second signal, passing the second signal through a speaker to cause the speaker to emit at least one sound wave, and providing a flexible membrane that oscillates in response to the sound wave and propels a particle away from the flexible membrane in a first direction to cause the space vessel to move in an opposite direction.

Embodiments of the method may include one or more of the following features or those described above. For example, the circuit may be tuned to cause the speaker to emit a sound wave at the resonant frequency of the flexible membrane. The ions may be provided by an ion collector. The speaker may be mounted at one end of a hollow body and the flexible membrane mounted at an opposite end of the hollow body.

The details of various embodiments of the invention are set forth in the accompanying drawings and the description below. Other features and advantages of the invention will be apparent from the description, drawings, and claims.

### DESCRIPTION OF THE DRAWINGS

FIG. 1 is a perspective view of a satellite using a satellite propulsion unit and the ion collector device.

FIG. 2 is a perspective view of the propulsion unit of the satellite of FIG. 1.

FIG. 3 is an end view of the propulsion unit of the satellite of FIG. 1.

FIG. 4 is a schematic drawing of the electrical circuit associated with the propulsion unit of FIGS. 2 and 3.

FIG. 5 is a perspective plan view of the ion collector system of the propulsion unit of FIG. 1.

FIG. 6 is a cross-sectional side view of the ion collector of the propulsion unit of FIG. 1.

FIG. 7 is a side view of a second implementation of a propulsion unit having an ion collector.

FIG. 8 is a cross-sectional side view of the propulsion unit and ion collector of claim 7.

FIG. 9 is a perspective view of a satellite having multiple propulsion units for steering and controlling the speed of the satellite.

### DETAILED DESCRIPTION

The inventor has developed a propulsion unit that can be used to propel a space ship, satellite, or other space craft or vessel in a zero gravity environment, such as outer space. As described in detail below, the propulsion unit relies upon the capture of radio-frequency (RF) waves to power a circuit that causes a speaker cone to directly or indirectly propel one or more particles or masses away from the propulsion unit. Although the propulsion unit is not expected to provide rapid acceleration, the unit is configured to provide steady, gradual acceleration. The inventor believes that such steady, gradual acceleration will be useful in space travel because of the immense distances involved. Moreover, in providing steady, gradual acceleration, the propulsion unit can be significantly reduced in size from the current systems used to propel vessels in space. This reduction in size will correspondingly significantly reduce the amount of fuel or propellant required to take the satellite from the earth's surface to space. Although a satellite is used to illustrate the invention in the drawings, the satellite could be replaced by any body or vessel that needs to be propelled into or within the zero-gravity environment of space.

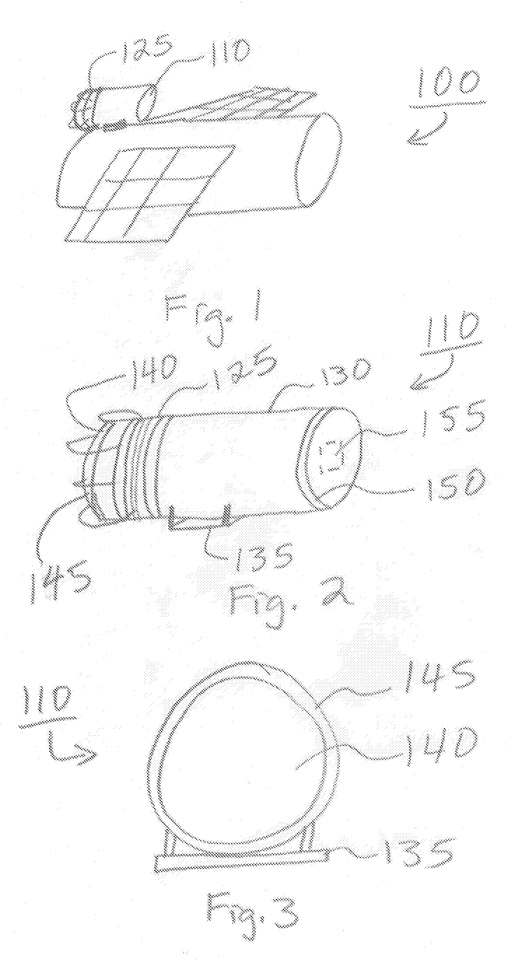

FIG. 1 depicts a propulsion unit 110 mounted to a satellite 100. An ion collector 125 is attached to the propulsion unit 110. In general, an ion collector is a device that is used to collect ions by creating a charge on a surface to attract the charged particles. As described in more detail below, while the ion collector 125 is existing, known technology, the inventor has developed a novel apparatus to generate the charge to collect the ions. As noted above, the satellite 100 may be another type of zero-gravity vessel and the use of a satellite is merely for purposes of illustrating the invention.

The propulsion unit may be integrally mounted to the satellite or may be manufactured on a one-size-fits-all basis. For example, the satellite or space vessel may have one or more mounting means to which one or more propulsion units can be placed. By selectively placing the propulsion units on the satellite or vessel, the propulsion units can be used to both propel and steer the satellite or vessel. For example, if one propulsion unit is placed on one side of the vessel and a second propulsion unit is placed on the opposite side of the vessel, by controlling the activation of each propulsion unit one can steer the vessel.

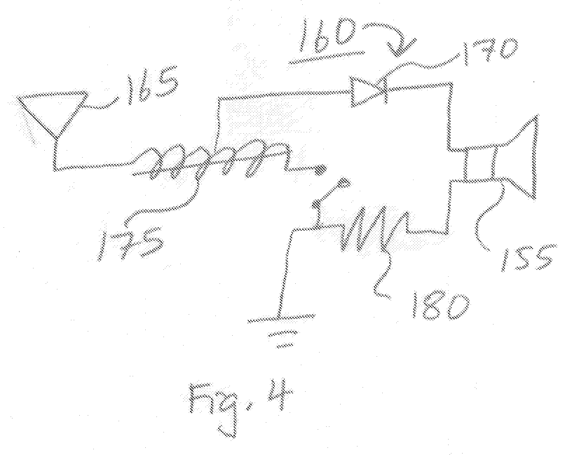

FIGS. 2 and 3 depict perspective and end views, respectively, of the propulsion unit 110 in isolation from the satellite 100. The propulsion unit 110 includes a tube 130 and mounting means 135 for mounting the propulsion unit to the satellite 100. At one end of the tube 130 is positioned a membrane or sheet of material 140, such as aluminum or Mylar®. The sheet of material 140 is sealed in place against the tube 130. The sheet of material is generally a flexible material that can be induced to flex outward and inward. As described below, the sheet of material may be varied considerably in shape, thickness, material and dimensions so long as it remains flexible.

The ion collector 125 is positioned on the tube 130, generally adjacent to the sheet of material 140. The ion collector 125 is used to capture ions and other charged particles in space and transfer them to the surface of the sheet 140. At the opposite end of the tube 130 is positioned a plate 150 on which is mounted a speaker cone 155 and associated circuitry (not shown). The circuitry captures RF waves and converts them into an electric current that powers the speaker to move the speaker cone. The circuitry may include components that permit the circuit to be tuned to the resonant frequency of the sheet 140 such that the sound emitted by the speaker causes the sheet 140 to resonate. The ion collector 125 is configured to place ions and other charged particles onto the sheet 140. By causing the sheet to resonate, the particles are propelled away from the sheet and thus the propulsion unit and satellite.

FIG. 4 is a schematic drawing of an electrical circuit 160 that can be used to cause the speaker 155 to oscillate. The circuit 160 includes an antenna 165, a GE diode (crystal) 170, a tuner 175, a resistor 180 and the speaker 155. The tuner 175 is used to tune the circuit such that the output from the speaker is at the resonant frequency of the sheet 140.

As is known, when a radio transmission is made, such as an AM broadcast, the waves go in multiple directions, including straying into space. The antenna in the electric circuit captures transmitted AM radio waves, which then are tuned to a particular frequency using the tuner 175 and passed to the GE diode 170. The GE diode converts the signal into a charge which travels through the circuit to the speaker 155. The charge causes the speaker to pulse or oscillate at a frequency which has been set using the tuner 175. The frequency generally will be the resonant frequency of the sheet 140. In this manner, the ions and other charged particles on the sheet 140 will be propelled away from the sheet by the oscillation of the sheet.

As is known, an oscillating movement by itself cannot propel an object in one direction or another in space because movement in one direction cancels out the movement in the opposite direction. The ion collector 125 solves this problem by attracting charged ions to the surface of the aluminum sheet 140. Expelling the charged ions-expelling mass-from the satellite body, causes it to move in the opposite direction of the mass expelled. In this way, the propulsion unit 110 can harness the oscillation movement to propel the satellite in a given direction.

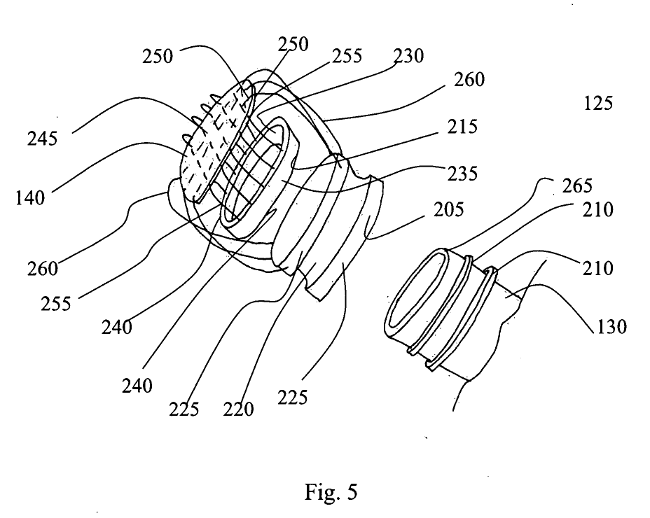

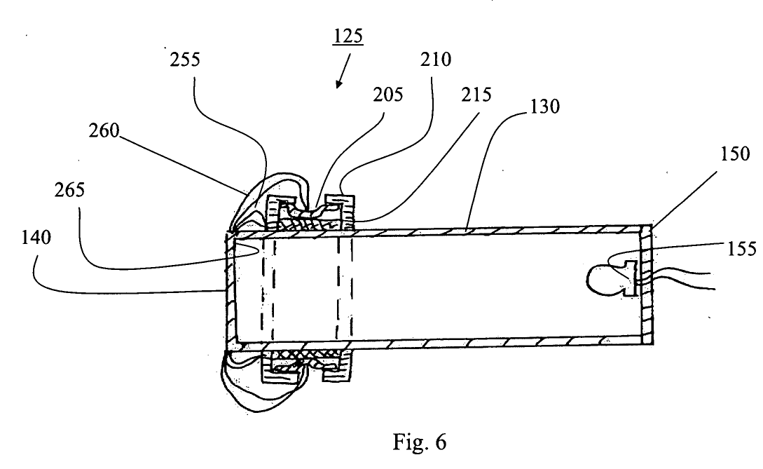

Referring to FIGS. 5 and 6, the ion collector 125 consists of a collar 205 mounted to a pair of rails 210 surrounding the circumference of the tube 130, a packing ring 215, and the sheet 140. The collar 205 is generally a round-shaped ring which has a section 220 that extends inward in the direction of the tube and a pair of lips or flanges 225 extending from opposite sides of the section 220. The lips or flanges 225 mate with the rail 210 to retain the collar 205 to the tube 130. The configuration of the rail 210 and lips or flanges 225 permits the collar 205 to vibrate against the rail and rotate around the circumference of the tube. The collar 205 is made of a material that is negative or very negative on the triboelectric scale. Examples of such materials include Teflon, silicon, polyvinyl chloride, polypropylene, polyethylene, polyurethane, Saran wrap, styrene, polyester, gold and platinum, brass and silver, nickel and copper, hard rubber, amber, and wood.

The packing ring 215 is made of a material that is positive or very positive on the triboelectric scale. Examples of such materials include rabbit fur, glass, human hair, nylon, wool, fur, lead, silk, aluminum, paper, and cotton. The packing ring is generally round and ring-shaped with an inner surface 230, an outer surface 235 and a pair of side edges 240. The packing ring is mounted to the tube and is stationary with respect to the tube. When the packing ring 215 is mounted to the tube 130, the packing ring's inner surface 230 is positioned against the outer surface of the tube and the side edges 240 are adjacent to the rails 210.

The collar 205 is configured such that when it is mounted to the rails 210, the section 220 has a surface that is in contact with the packing ring. In this manner, when the collar vibrates against the rails or rotates around the rails, the movement causes the collar to move against the packing ring. As noted about, the collar is made of a material that is negative on the triboelectric scale relative to the material used to make the packing ring. Because of these properties, movement of the collar against the packing ring causes the formation of a charge on the collar and packing ring.

When used with an ion collector source 125, the sheet 140 is fabricated to include a mesh or grid of fibers 245. The layout of the grid of fibers is much like that of an air filter for a heating or cooling system. To incorporate the fiber mesh, the sheet 140 may be fabricated from a pair of thin sheets 245 of a metallic material, Mylar®, a metalized polymer, or the like, which have the fiber grid 245 positioned between the two thin sheets. The fiber grid is made up of fibers that pass across and extend from the sheets to be connected to one or the other of the collar and packing ring. One set of fibers 255 may be of the same type of material as the packing ring and extend from opposite sides of the sheets to attach to the packing ring. The other set of fibers 260 may be of the same type of material as the collar and extend from opposite side of the sheets to attach to the collar. In this manner, when a charge is created on the collar and packing ring, the charge will be transferred to the sheets 250 via the fibers 255, 260 connecting the sheets to the collar 205 or packing ring 215. The charges thereby formed on the sheets will attract charged particles from the surrounding atmosphere of space.

The sheet 140 is attached to the tube 130 to form a seal with the outer edge or lip 265 of the tube. By sealing both ends of the tube, the inner chamber is kept closed and pressurized to approximately 14.7 psi to simulate Earth's atmospheric pressure. The rotational movement of the collar 205 around the tube may be limited to prevent putting too much stress on the fibers 255, 260.

The circuit may be tuned to emit a sound that is at a resonant frequency of the sheet 140. By emitting the sound at the resonant frequency, the sound will cause the sheet 140 to vibrate and propel the charged particles away from the sheet.

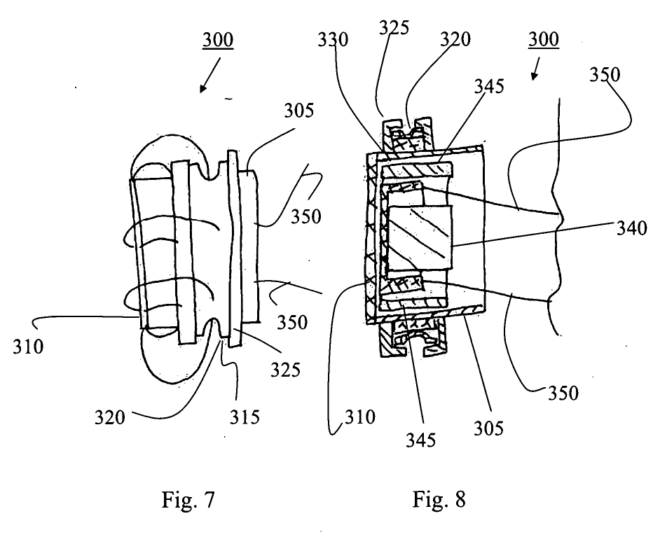

Referring to FIGS. 7 and 8, in another implementation, a propulsion unit 300 is a modified version of the propulsion unit 125. The propulsion unit 300 includes a tube or cylinder 305; a sheet 310; and an ion collector system 315 that includes a collar 320, rail 325 and packing ring 330. The sheet 310 functions as a speaker cone and is connected to a voice coil 335, pole piece 340, and a magnetic 345. The voice coil 335 is wired to the GE diode/RF energy circuit described above in FIG. 4 using wires 350. In this manner, the ion collector system 315 attracts charged particles to the sheet 310 and those particles are propelled away from the sheet by the movement of the sheet in response to the circuit through the voice coil.

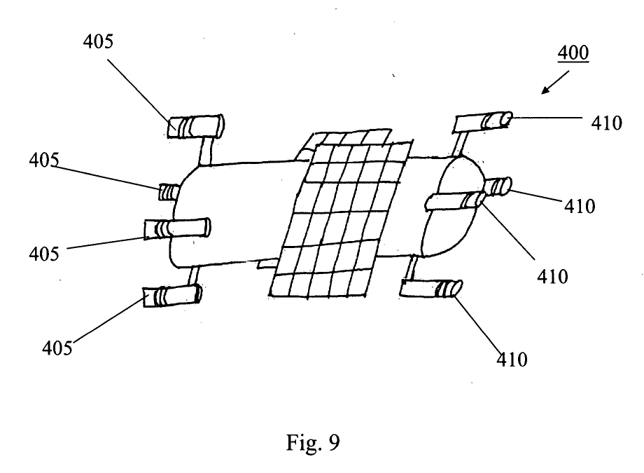

Referring to FIG. 9, a satellite 400 can be configured with multiple propulsion units to control speed and direction of movement of the satellite. A first set of forward propulsion units 405 can be used to move the satellite forward towards the intended destination. A second set of propulsion units 410 can be used to slow the satellite as it approaches its destination or as otherwise needed. Although FIG. 9 shows four forward thrusting propulsion units 405 and four reverse thrusting propulsion units 410 each placed around the periphery of the satellite, the number and placement of the propulsion units can be varied. For example, the satellite can be configured to have one reverse thrusting propulsion unit positioned at the center of the satellite rather than the periphery. Similarly, the satellite can have three forward thrusting propulsion units spaced around the periphery of the satellite.

A computer system can be used to determine which propulsion units to activate to either move the satellite forward, change its direction, or slow down the satellite. The computer system can be contained within the satellite or part of a remote control center that controls the operation of the satellite. Thus, an operator at the remote control center can determine which engines to use or not use to propel, change direction, or slow the movement of the satellite. The operator at the remote control center also can direct RF waves at the satellite to power the propulsion units. Alternatively, a transmitter can be stationed in space and used to transmit RF waves to propel the satellite. Such a satellite can be powered by solar power.

While several particular forms of the propulsion system have been illustrated and described, it will be apparent that various modifications and combinations of the invention detailed in the text and drawings can be made without departing from the spirit and scope of the invention. For example, references to materials of construction, methods of construction, specific dimensions, shapes, utilities or applications are also not intended to be limiting in any manner and other materials and dimensions could be substituted and remain within the spirit and scope of the invention. Accordingly, it is not intended that the invention be limited, except as by the appended claims.

What is claimed is:

1. A space vessel comprising;
at least one propulsion unit mounted to the vessel and comprising a hollow body having a first end and a second end, the first end comprising a circuit and a speaker, the second end comprising a flexible membrane; the circuit comprising an antenna and a diode, the speaker configured to receive the signal from the circuit; and
a source of particles.

2. The space vessel of claim 1, further comprising an ion collector configured to provide the particles.

3. The space vessel of claim 2, wherein the ion collector is configured to provide the particles onto the flexible membrane.

4. The space vessel of claim 3, wherein the ion collector comprises a packing ring mounted to the hollow body and comprising a first material, a collar adjacent to the packing ring and comprising a second material, and a fiber mesh within the sheet, the fiber mesh comprising the first material and the second material and being in continuity with the first material of the packing ring and the second material of the collar, the first material and the second material being made of materials having a difference on the triboelectric scale whereby a movement of the collar against the packing ring causes the creation of a charge resulting from the different in the triboelectric values.

5. The space vessel of claim 1, wherein the circuit further comprises a circuit element to tune the frequency of the circuit.

6. The space vessel of claim 5, wherein the frequency of the circuit is the resonant frequency of the flexible membrane mounted to the hollow body.

7. The space vessel of claim 1, further comprising multiple propulsion units mounted to the space vessel.

8. The space vessel of claim 7, wherein the propulsion units provide one or more of forward thrust, reverse thrust, and direction control.

9. The space vessel of claim 8, wherein the propulsion units are controlled from a remote location.

10. The space vessel of claim 1, wherein the flexible membrane comprises one or more of a Mylar sheet or an aluminum sheet.

11. The space vessel of claim 1, wherein the antenna is configured to receive radio-frequency waves.

12. The space vessel of claim 1, wherein the diode is a GE diode.

13. A propulsion unit for a space vessel, the component comprising a hollow body having a first end and a second end,
the first end comprising a circuit and a speaker, the circuit comprising an antenna configured to receive radio-frequency waves and a diode configured to convert the radio-frequency waves into a signal in the circuit, the speaker configured to receive the signal from the circuit and oscillate such that the speaker emits a sound; and
the second end comprising a flexible membrane configured to flex as a result of the sound emitted by the speaker.

14. The propulsion unit of claim 13, further comprising an ion collector for providing ions and charged particles.

15. The propulsion unit of claim 14, wherein the ion collector and propulsion unit are mounted to a space vessel.

16. The component for a propulsion unit of claim 13, wherein the diode comprises a GE diode.

17. A method of propelling a space vessel, the method comprising:
receiving radio-frequency waves at an antenna to create a signal in a circuit, modifying the signal in the circuit with a GE diode to create a second signal, passing the second signal through a speaker to cause the speaker to emit at least one sound wave, and providing a flexible membrane that oscillates in response to the sound wave and propels a particle away from the flexible membrane in a first direction to cause the space vessel to move in an opposite direction.

18. The method of claim 17 wherein the circuit is tuned to cause the speaker to emit a sound wave at the resonant frequency of the flexible membrane.

19. The method of claim 17 wherein the ions are provided by an ion collector.

20. The method of claim 17 wherein the speaker is mounted at one end of a hollow body and the flexible membrane is mounted at an opposite end of the hollow body.
